(19) United States
(12) Patent Application Publication
(10) Pub. No.: US 2017/0364969 A1
(43) Pub. Date: Dec. 21, 2017

(54) CAR RENTAL SYSTEM AND METHOD VIA PRICE ADJUSTMENT

(71) Applicant: JEJUPASS CO., LTD., Jeju-si (KR)

(72) Inventor: Hyung Joon YOON, Goyang-si (KR)

(73) Assignee: JEJUPASS CO., LTD., Jeju-si (KR)

(21) Appl. No.: 15/622,184

(22) Filed: Jun. 14, 2017

(30) Foreign Application Priority Data
Jun. 15, 2016 (KR) 10-2016-0074791

(51) Int. Cl. G06Q 30/02; G06Q 10/06; G06Q 10/08; G06Q 30/06

(52) U.S. Cl. CPC G06Q 30/0283; G06Q 30/0645; G06Q 10/06313; G06Q 10/06314; G06Q 10/087

(57) ABSTRACT

A car rental system through price adjustment includes a rental-car information provision server configured to collect and manage rental-car data, a rental-car management unit connected to the rental-car information provision server and configured to manage an application program and to deliver rental-car management information of the car-rental company to the rental-car information provision server, a search database configured to collect rental-car demand information, a price adjustment server configured to collect a desired car model, price and demand during the specific period within a predetermined area from the search database, to analyze a demand and schedule of the user, a desired price category of the user, a real-time total stock of the car-rental company and a base price as variables, and to provide an adjusted rental price to the user along with the search result, and a user terminal configured to request price comparison search for an available rental car.

### BACKGROUND OF THE INVENTION

### 1. Field of the Invention

The present invention relates to a car rental system and method via price adjustment and, more particularly, to a car rental system and method via price adjustment, which is capable of reasonably renting a car by analyzing a rental price and real-time car provision state of each car-rental company using a demand, schedule and desired price category of a user, who requests a rental price and price comparison search, as variables when the user selects a desired car model according to a schedule or itinerary thereof, calculating a discount rate or an increase rate, providing the car-rental company and the user with a real-time rental price and insurance premium obtained by adjusting the predetermined price of the car-rental company.

### 2. Description of the Related Art

In a conventional car rental method, a user, who wants to rent a car, directly visits or places a call to a car-rental company to check whether there is a car available during a specific period, thereby troublesomely renting a car. In addition, if there is no car available during the specific period, the user should directly and repeatedly visit in or place a call to another car-rental company to check whether there is an available car, thereby causing inconvenience.

As use of car-rental services has rapidly increased, large car-rental companies have established rental-car management programs to efficiently manage rental cars. However, small car-rental companies purchase rental-car management software and pay fees for use of the software, use a program such as Excel or handwrite a management book, since it is difficult to establish such a management program.

Although the car-rental market is booming, small car-rental companies cannot efficiently manage rental cars. Since small car-rental companies individually fulfill sales activities, a plurality of cars may be idle during off-season and thus management costs may be increased, thereby increasing the rental price and decreasing the demand for rental cars. Therefore, a vicious cycle is repeated.

As a result, the demand for rental cars and the supply of the rental cars by the car-rental companies in a predetermined area are in an imbalanced state, and data on supply of the rental cars of the car-rental companies and the rental dates and times and return dates and times of the users are not comprehensively managed, such that a rental car may not be supplied to a user at a proper time.

A user tends to rent a car of a desired model during a specific period according to a schedule or itinerary thereof even when the rental price is slightly high. If integrated data cannot be collected, the car rental company preferentially supplies a rental car to a user, who already reserved the rental car, and cannot supply a rental car to another user, who wants to rent the car of the desired model, at a proper time, such that the car-rental company cannot make further earnings.

Although rentals are low during the off-season, appropriate discount rates for rental cars cannot be proposed. Therefore, car-rental companies are in a severely imbalanced state in terms of car supply.

### RELATED ART DOCUMENT

### Patent Document

Korean Patent No. 10-1006598

Korean Laid-Open Patent Publication No. 10-2013-0053125

### SUMMARY OF THE INVENTION

Therefore, the present invention has been made in view of the above problems, and it is an object of the present invention to provide a car rental system and method via price adjustment, which is capable of reasonably renting a car by analyzing a rental price and real-time car provision state of each car-rental company using a demand, schedule and desired price category of a user, who requests a rental price and price comparison search, as variables when the user selects a desired car model according to a schedule or itinerary thereof, calculating a discount rate or an increase rate, providing the car-rental company and the user with a real-time rental price and insurance premium obtained by adjusting the predetermined price of the car-rental company.

In accordance with the present invention, the above and other objects can be accomplished by the provision of a car rental system through price adjustment including a rental-car information provision server configured to collect and manage rental-car data including utilization prices of a list of cars rentable during a specific period, a rental-car management unit connected to the rental-car information provision server and configured to manage an application program for managing rental car information in a car-rental company and to deliver rental-car management information of the car-rental company to the rental-car information provision server, a search database configured to collect rental-car demand information according to a search request of a user who wants to use a rental car during a specific period, a price adjustment server configured to collect a desired car model, price and demand during the specific period within a predetermined area from the search database, to analyze a demand and schedule of the user, a desired price category of the user, a real-time total stock of the car-rental company and a base price as variables based on supply information of available rental cars of the car-rental company and the base price of the car-rental company to calculate a price, and to provide an adjusted rental price to the user along with the search result, and a user terminal configured to request price comparison search for an available rental car including a rental price of a rental car of a desired model to be rented by the user during the specific period from the price adjustment server through a communication network.

In accordance with an aspect of the present invention, the above and other objects can be accomplished by the provision of a car rental method including a user terminal requesting search for a rental car to be rented during a specific period from a price adjustment server, the price adjustment server storing search information including a use period, model and desired price of the rental car received from the user terminal in a search database, the price adjustment server delivering the search information to a rental-car information provision server and requesting search for the rental car, the rental-car information provision server requesting search for a list of rental cars and use prices thereof from a rental-car management unit of a car-rental company and the rental-car management unit transmitting a search result to the rental-car information provision server in response thereto, the price adjustment server receiving the search result from the rental-car information provision server and analyzing a demand and schedule of a user, a desired price category of the user, a real-time total stock of the car-rental company and a base price as variables to calculate a price, and adjusting a rental price, and the price adjustment server providing information on the adjusted rental price to the user terminal along with the search result.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing the configuration of a car rental system according to the present invention;

FIG. 2 is a block diagram showing connection of car rental systems according to an embodiment of the present invention;

FIG. 3 is a block diagram showing, in detail, a price adjustment server in a car rental system according to an embodiment of the present invention;

FIG. 4 is a block diagram showing, in detail, a price adjustment server in a car rental system according to another embodiment of the present invention;

FIG. 5 is a flowchart illustrating a car rental method according to an embodiment of the present invention; and

FIG. 6 is a flowchart illustrating a car rental method according to another embodiment of the present invention.

### DETAILED DESCRIPTION OF THE PREFERRED EMBODIMENTS

Hereinafter, a system and method for managing a rental car through price comparison according to an embodiment of the present invention will be described in detail with reference to the accompanying drawings.

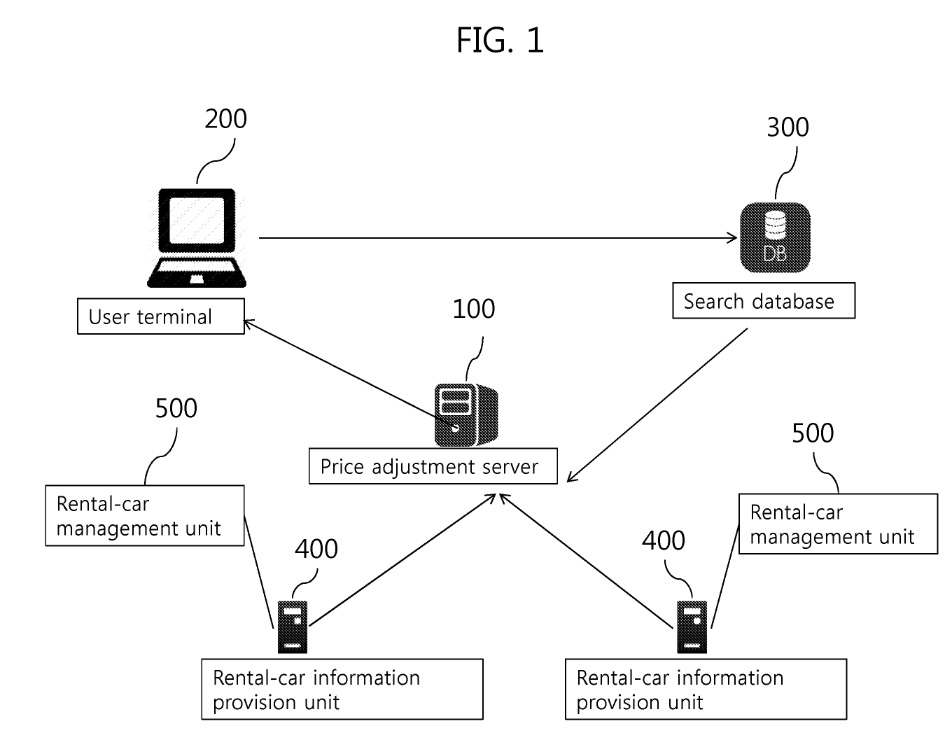

FIG. 1 is a schematic diagram showing the configuration of a car rental system according to the present invention.

Referring to FIG. 1, the car rental system according to the embodiment of the present invention includes a price adjustment server 100 for providing car information and price information, a user terminal 200 for requesting rental-car price comparison search, a search database 300 for collecting and storing search data, a rental-car information provision server 400 for collecting and managing rental car information, and a rental-car management unit 500 for managing rental car information in a car-rental company.

The rental-car information provision server 400 collects and manages rental car information including a list of cars rentable during a specific period and prices thereof and delivers the rental car information to the rental-car management server 100.

The rental-car management unit 500 is connected to the rental-car information provision server 400 to manage an application program for managing rental car information of the car-rental company and to deliver rental-car management information of the car-rental company to the rental-car information provision server 400.

The user terminal 200 requests price comparison search of an available rental car including the rental price of the car of a desired model to be rented during a specific period from the rental-car management server 100 through a communication network.

When the user terminal 200 requests price comparison search of an available rental car including the rental price of the car of a desired model to be rented during a specific period from the price adjustment server 100 through the communication network, the search database 300 collects rental-car demand information according to the search request of the user who will use the rental car during the specific period.

The price adjustment server 100 collects the desired model, price and demand during the specific period within a predetermined area from the search database, analyzes a demand and schedule of the user, a desired price category of the user, and the real-time total stock and base price of the car-rental company as variables based on supply information of available rental cars of the car-rental company and the base prices thereof to calculate a discount rate or an increase rate, provides an adjusted rental price to the user terminal along with the search results.

In FIG. 1, two or more rental-car information provision servers 400 are connected to the price adjustment server 100 and two or more rental-car management units 500 are connected to one rental-car information provision server 400.

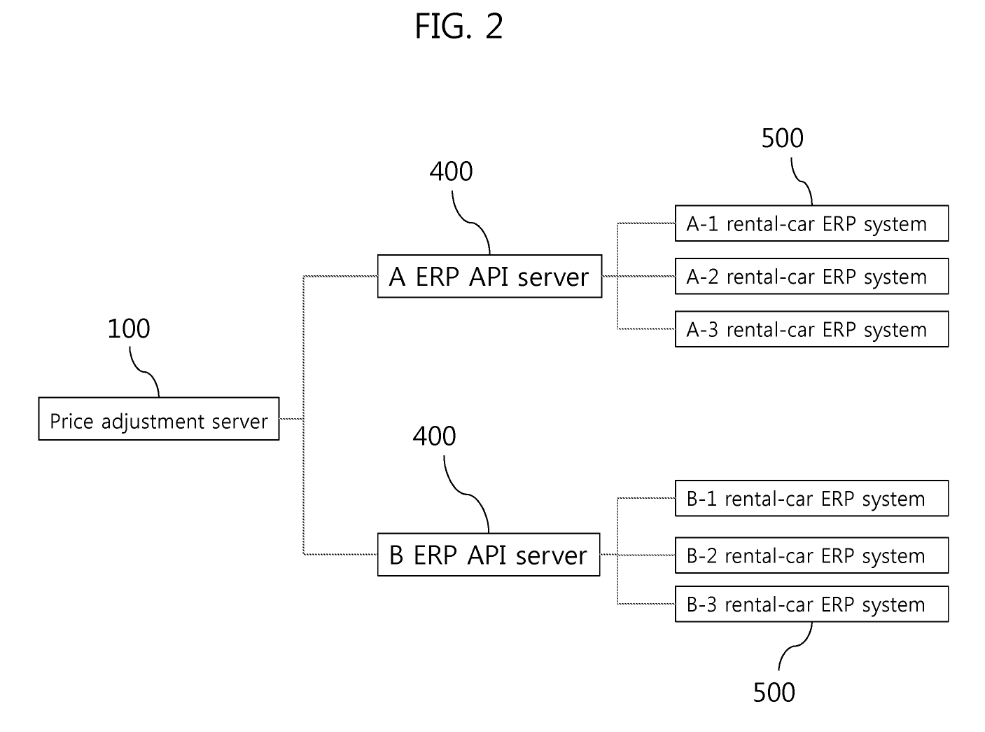

FIG. 2 is a block diagram showing connection of car rental systems according to an embodiment of the present invention.

In the embodiment of FIG. 2, the rental-car information provision server 400 provides ERP software for managing rental car information to the car-rental company and includes an ERP API server for managing rental car information and information on reservation, payment and use state of rental cars. The rental-car management unit 500 corresponds to an ERP system of a car-rental company which is connected to the ERP API server of the rental-car information provision server 400 to manage an application program for managing rental car information of the car-rental company.

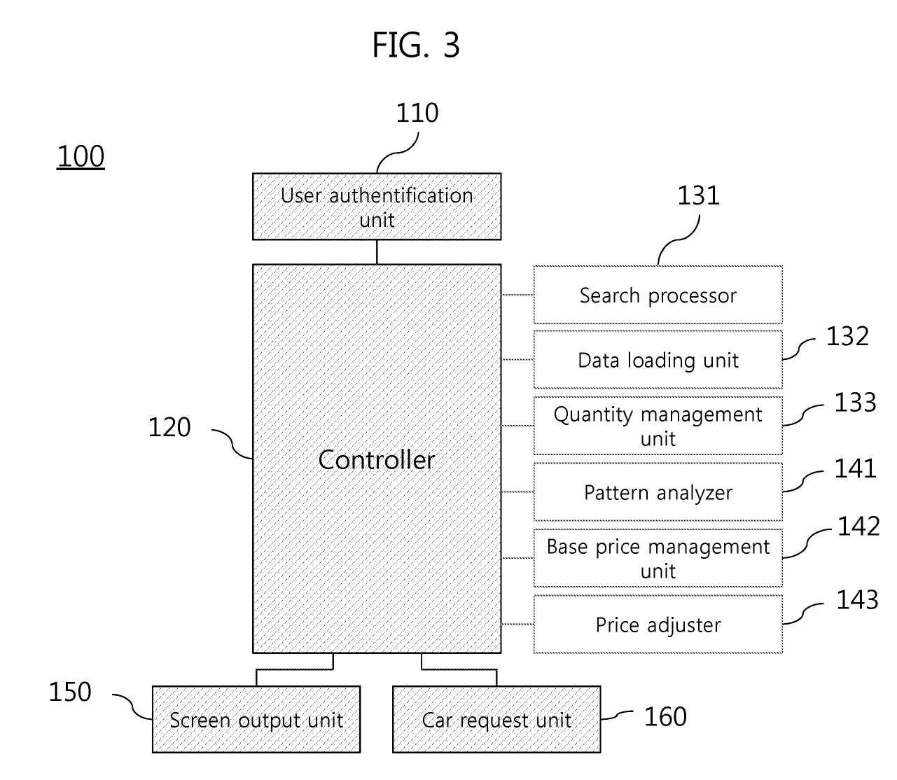

FIG. 3 is a block diagram showing, in detail, a price adjustment server in a car rental system according to an embodiment of the present invention.

Referring to FIG. 3, the price adjustment server 100 includes a user authentication unit 110, a controller 120, a search processor 131, a data loading unit 132 and a quantity controller 133. A price adjustment processor 140 includes a pattern analyzer 141, a base price management unit 142, a price adjuster 143, a screen output unit 150 and a car request unit 160.

The user authentication unit 110 processes real-time reservation and payment information of a rental car available during a desired period from the user terminal 200 in the price adjustment server 100.

When the user terminal 200 requests price comparison search of an available rental car including the rental price of the car of a desired model to be rented during a specific period, a real-time search state may be displayed on the user terminal without a login process. However, in order to process personal information for real-time rental-car reservation and payment, a login process needs to be performed to perform authentication using the user authentication unit 110.

In the login process, an email ID and a password may be set in order to minimize the amount of personal information of the user.

The search processor 131 receives the request for price comparison search of the car of the desired model to be rented during the specific period from the user terminal 100, requests search data according to a rental date and time, a return date and time and the model of the car from the rental-car management unit 500, and provides the model and rental price of the car in real time as the search result.

That is, the search processor 131 searches for cars suitable for a rental start date and time, a rental end date and time, insurance (general insurance or full insurance), car classification (light car, small car, midsize car, luxury car, SUV/RV or van), gender or age in a data field through the ERP system and calculates an insurance premium.

The data loading unit 132 retrieves and loads search data of a rental date and time, a return date and time and car classification from the user terminal 200, user information, a user search time, data on a search result, and information on final payment of the user from the search database 300 to the price adjustment server 100.

The data field of the data loading unit 132 includes a start date, a start time, a return date, a return time, insurance (general automobile physical damage insurance or full automobile physical damage insurance), car classification (light car, small car, midsize car, luxury car, SUV/RV or van), gender (male or female), age, search time, selected car model (light car, small car, midsize car, luxury car, SUV/RV or van), selected car, fuel type (gasoline, diesel, LPG, electric or hybrid), car price, insurance premium and payment. The data loading unit loads such data.

The quantity management unit 133 updates information on cars possessed by each car-rental company in real time and stores a car stock state.

The quantity management unit 133 stores the quantity of cars when the user searches for or rents a rental car and stores and manages the total stock and a rate of sales of the car.

The data field of the quantity management unit 133 includes car classification (light car, small car, midsize car, luxury car, SUV/RV or van), base time, and the quantity of cars possessed by each car-rental company.

The pattern analyzer 141 specifies the demand and schedule of the user who requests price comparison search, the input value of the user for the desired price category and the data on the search result as variables and calculates the adjustable price of the searched car or rental car using the variables.

The pattern analyzer 141 calculates the rental price of the rental car using a rental period according to weekday or weekend, the number of rental cars rented on a day when the user searches for a rental car, the number of rental cars of a fuel type selected by users rented on a day when the user searches for a rental car, reduction in number of remaining cars during one hour from a search time and an average rental price of car rental companies on a day when the user searches for a rental car as variables.

Weights are applied to the variables such as the rental period according to weekday or weekend, the number of cars rented on the day when the user searches for the rental car, the number of rental cars of the fuel type selected by users rented on the day when the user searches for the rental car. The pattern analyzer 141 calculates the rental price of the rental car by applying weights.

The variables applied by the pattern analyzer 141 according to one embodiment of the present invention will now be described.

On the assumption that the utilization price proposed by the car-rental company is discounted, the pattern analyzer 141 analyzes a user input value and a pattern of a searched data and specifies a variable as follows.

Variable 1 is related to a ratio of weekend days to weekdays. A weight is applied to variable 1 to calculate a rental price.

That is, a weight is applied to variable 1 according to a weekend or weekday. When a utilization price proposed by a car-rental company is 24,000 and a rental period or a reservation period includes one weekend day and two weekdays, a weight is applied to a variable (1/3=0.3) obtained by the ratio of weekend days to weekdays, thereby calculating the following price.

24,000 (utilization price)−((0.3*1.5 (weight)/10)*24,000 (utilization price))=22,920

Variable 2 is related to the number of cars rented on a current date and is used to calculate a price.

That is, a weight is applied to a variable 2 (1/15=0.06) which is a ratio of the number of times of reservation to the number of times of searching for the rental price of car to calculate the following price.

24,000 (utilization price)−((0.06*1 (weight))*24,000 (utilization price))=22,560

Variable 3 is related to the number of cars of the fuel type selected by users on a current date and is used to calculate a price.

That is, when the number of gasoline cars selected by users today is 25, the number of diesel cars selected by users today is 10 and the number of LPG cars selected by users today is 60 and a user selects a gasoline car, a weight is applied to variable 3 (25/(10+60)=0.3) according to fuel type, thereby calculating the following price.

24000 (price)−((0.3*0.6 (weight))*24,000 (price))=19,680

Variable 4 is related to the total number of remaining cars and is used to calculate a rental price.

That is, variable 4 indicates the number of remaining cars and is calculated as reduction in number of cars per hour. When the number of cars is 46 at 10:00 and is 45 at 10:59, variable 4 (46/(45+46))²=0.2 is considered, thereby calculating the following price.

24000 (price)—(0.2*24,000 (price))=19,200

Variable 5 is an average price of the car in car-rental companies on a current date as a comparison value.

That is, variable 5 is an average price of the car today. When prices of the same car of three car-rental companies are 19,000, 20,000 and 22,000, the average price is obtained as follows.

(19,000+20,000+22,000)/3=20,333

The base price management unit 142 stores a price range of each car-rental company as a base price.

A lowest price among prices, to which the variables calculated in the pattern analyzer 141 are applied, is compared with a base price range determined by the car-rental company.

In the above example, the base price of a gasoline car defined by the car rental company is 24,000 won, a lowest price is 15,000 won, and a highest price is 55,000 won.

At this time, the price adjuster 143 applies a price calculated according to the variable specified by the pattern analyzer 141 within the base price range to adjust the price.

In the above example, since the lowest price of the prices calculated according to variables 1 to 4 is less than the average price (variable 5), the calculated price is selected.

In addition, since the calculated price is between the lowest price and the highest price of the car-rental company, the calculated price is provided to and displayed on the user terminal 200 as an adjusted price, such that the price of the rental car is adjusted from 24,000 proposed by the car-rental company to 19,200.

Here, when the lowest price of the calculated prices obtained by applying the variables calculated by the pattern analyzer 141 is within the base price range as a result of comparison with the base price range determined by the car rental company, the calculated price is set as the adjusted price of the rental car and, when the calculated price calculated by applying the variables is less than the lowest price, the lowest price of the car rental company is set as the rental price of the rental car.

Meanwhile, the screen output unit 150 outputs information on an available car, the price of which is discounted or increased per car rental company in real time, and information on the adjusted price on the screen of the user terminal 200, as a result generated by the price adjuster 143 according to the request for price comparison search of the rental car from the user terminal 200.

In addition, the car request unit 160 requests car allocation with respect to the car of the car-rental company, real-time reservation of and payment for which have been made in the user terminal 200.

The data field of the car request unit 160 includes a car code, a company code, a rental date, a return date, an insurance code, a rental price, an insurance premium, a reservation number, a user name and a user contact.

The controller 120 receives a comparison search request from the user terminal 200, loads data searched for by the search processor 131 using the data loading unit 132, manages the quantity of cars, compares a result calculated using the variables specified by the pattern analyzer 141 with a base price, and adjusts a price.

The controller 120 receives a comparison search request from the user terminal 200, requests for price adjustment of a rentable car searched and processed by the data processor 130 from the price adjustment processor 140, outputs the requested result on the screen, receives reservation and payment information from the user terminal 200, and inputs car allocation information to the car request unit 160.

Meanwhile, the price adjustment server 100 receives a request for price comparison search of the car of a desired model to be rented during a specific period from the user terminal 200 and provides car information and price information. The car information includes insurance application information and the price information includes an insurance premium.

The insurance premium includes an insurance premium per car model and an insurance premium having a fixed exemption limit according to car-rental company, for automobile damage exemption.

The insurance is automobile physical damage insurance and includes general insurance and full insurance. Given full insurance, an exemption fee and a non-operation charge (NOC) are completely exempted and, given the general insurance, an exemption fee is generated within a range of 20% of the repair charges of a car and about 50% of the rental price is generated as the NOC. The lowest fee and highest fee of each company are differently set.

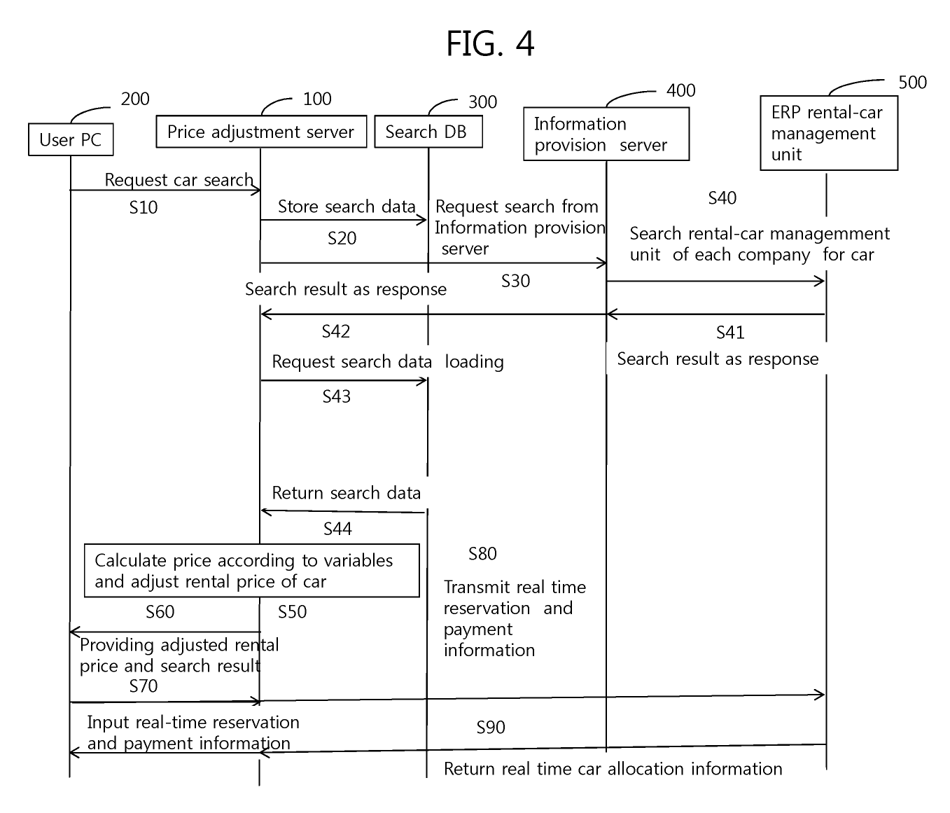

FIG. 4 is a flowchart illustrating a car rental method according to another embodiment of the present invention.

First, the user terminal 200 requests search for a desired car capable of being rented during a specific period from the price adjustment server 100 (S10).

At this time, price comparison search for a rental car may be performed in real time without a user login process. If the login process is performed, a search process is performed after performing user authentication using an email ID and a password and search data is stored to be used as statistical information.

The price adjustment server 100 stores search data including a use period, a desired model, a desired price of a rental car received from the user terminal 200 in the search database 300 (S20).

The stored search data is source data for price adjustment and is delivered to the pattern analyzer 141 through the data loading unit 132.

Next, the price adjustment server 100 delivers the search data to the rental-car information provision server and requests search for a rental car (S30).

The rental-car information provision server 400 searches the rental-car management unit 500 for a list of rental cars and prices thereof per car-rental company in response to the car search request from the rental-car management server 100 and delivers the search result to the rental-car management server 100 through the rental-car information provision server 400 in response thereto (S40, S41, and S42).

The price adjustment server 100 requests rental-car search information of the user collected from the search database 300 (S43) and the search database 300 returns the search information of the user to the rental-car management server 100 (S44).

Next, the price adjustment server 100 receives the search result from the rental-car information provision server 400, analyzes a demand and schedule of the user, a desired price category, a real-time total stock of the car-rental company and a base price as variables to calculate an price, and adjusts a rental price (S50).

At this time, when the quantity management unit 133 determines that the price needs to be adjusted, the pattern analyzer 141 analyzes the user input value and the searched data.

According to the result of analysis of the pattern analyzer 141, the price adjuster 143 adjusts the price using the variables obtained by the pattern analyzer 141.

Here, the price adjustment server 100 selects the price calculated using the variables as the rental price if the calculated price is within a range from a minimum price to a maximum price of the base price of the sales car set per car-rental company.

That is, a highest price, to which the increase rate is applied, and a lowest price to which the discount rate is applied, of the prices calculated using the variables, are selected, the calculated price is selected as the rental price if the base price of each company stored in the base price management unit 142 is within the range from the minimum price and the maximum price, the minimum price is selected as the rental price if the base price of each company stored in the base price management unit 142 is less than the minimum price, and the maximum price is selected as the rental price if the base price of each company stored in the base price management unit 142 is greater than the maximum price.

Hereinafter, methods of adjusting a price upward and downward will be described in detail.

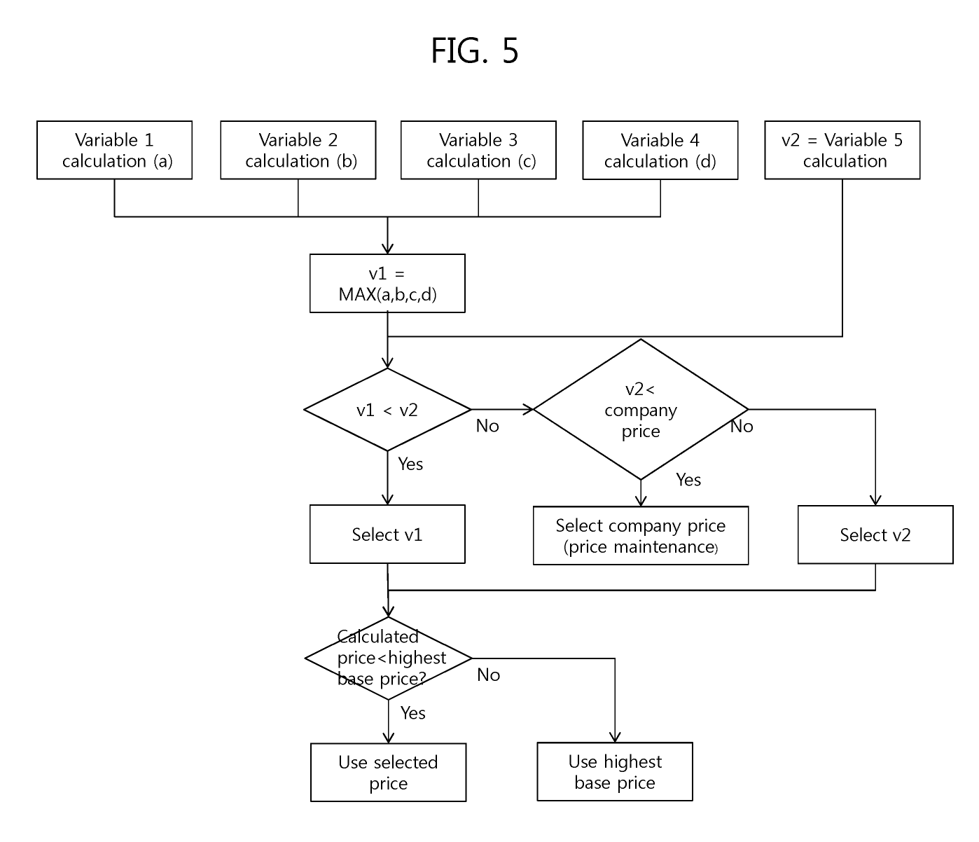

FIG. 5 is a flowchart illustrating a method of adjusting a process upward according to an embodiment of the present invention.

In one embodiment, assume that a user searches for a K5 car (LPG) during a period from May 12 (TUR), 2016, 2:00 PM to May 15 (SUN), 2016, 4:00 PM.

A total number of K5 (LPG) cars was 100, 80 K5 (LPG) cars were rented, and 20 K5 (LPG) cars remained. The number of times of searching for the K5 (LPG) car today was 30 and the number of reserved cars was 4.

The number of gasoline cars today was 25, the number of LPG cars was 60, the number of diesel cars was 10, and the number of K5 (LPG) cars was reduced from 25 to 15 in one hour, that is, 10 K5 (LPG) cars were rented in one hour. Among a total of 10 car-rental companies, the number of car-rental companies capable of renting the K5 (LPG) car was 5 and the prices of the K5 (LPG) cars of the car-rental companies were respectively 19,000, 22,000, 25,000, 25,000 and 29,000.

The minimum price of the K5 (LPG) car is 15,000, the maximum price thereof is 55,000, and the price defined by the company is 19,000.

When the price is obtained depending on whether the rental period is a weekday or weekend according to variable 1, since the rental period includes two weekdays and two weekend days, the variable (2/4=0.5) is calculated, and

((0.5*1.5 (weight)/10)+1)*19,000 (base price of the company)=20,425

is obtained. Therefore, 20,425 won (a) is calculated using variable 1.

When the price is obtained using variable 2, that is, the number of rented cars, a weight is applied to the variable (4/30=0.13) which is a ratio of the number (4) of times of reservation to the number (30) of times of searching for the car rental price, thereby calculating the following price.

((0.13*0.8 (weight)/10)+1)*19,000 (base price of the company)=19,190

Therefore, 19,190 won (b) is calculated using variable 2.

Variable 3, that is, the number of cars of a fuel type selected by users on the current date, is applied to calculate the price.

That is, because the number of gasoline cars of selected by users today was 25, the number of diesel cars of selected by users today was 10, the number of LPG cars selected by users today was 60 and the user selected the LPG car, a weight is applied to the variable 3 (60/(25+10)=1.71), thereby calculating the following price.

((1.71*0.6 (weight)/10)+1)*19,000 (base price of the company)=20,900

Therefore, 20,900 won (c) is calculated using variable 3.

Variable 4, that is, the total number of remaining cars, is obtained to calculate the price.

That is, variable 4 indicates the number of remaining cars and is calculated as reduction in number of cars per hour. When the number of cars is 25 at 10:00 and is 10 at 10:59, variable 4 ((25/(10+25))+0.4)²=1.23 is obtained to calculate the following price.

1.23*19,000 (base price of the company)=23,370

Therefore, 23, 370 won (d) is calculated using variable 4.

In the above processes, the maximum price v1 of the prices a, b, c and d calculated using variables 1 to 4 is 23,370 won.

Variable 5 is the average price of the car in car-rental companies on the current date as a comparison value.

That is, variable 5 is an average price of the car on the current date. When the prices of the same car in five car-rental companies are 19,000, 22,000, 25,000, 25,000, 29,000, the average price is obtained as follows.

(19,000+22,000+25,000+25,000+29,000)/5=24,000 won (e).

At this time, price adjustment is performed using the variables in the price adjuster 143.

The highest price of the prices calculated using variables 1, 2, 3 and 4 is selected. This price is referred to as a calculated price v1 (23,370 won) and the price of variable 5 is referred to as an average price v2 (24,000).

Since the calculated price (the maximum price of the prices obtained by variables 1 to 4) is less than the average price (variable 5) (v1<v2), the calculated price is selected as an adjusted price.

If v1 is greater than v2, the smaller price of v2 and the price of the company is selected.

Since the adjusted price (23,370 won) is within a range between the minimum price (15,000) and the maximum price (55,000), the adjusted price may be displayed to the user and the price of the company may be adjusted from 19,000 to 23,370.

If the adjusted price is less than the minimum price, the minimum price is selected as the rental price.

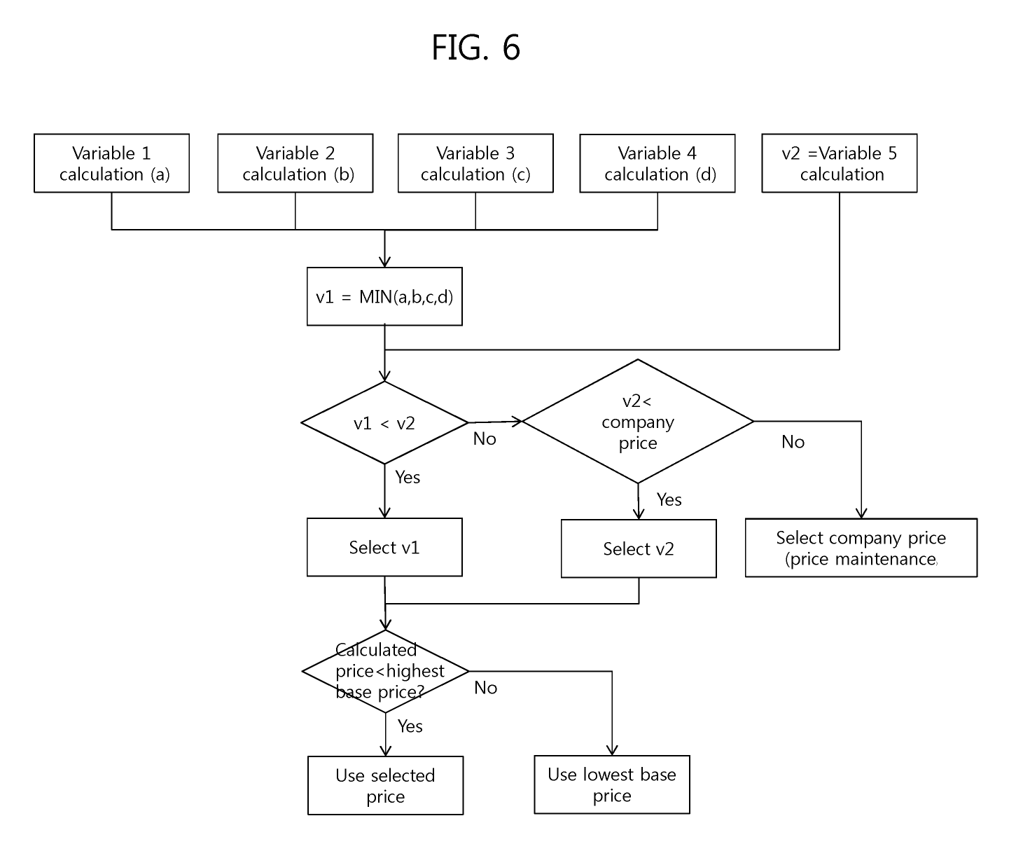

FIG. 6 is a flowchart illustrating a method of adjusting a process downward according to an embodiment of the present invention.

For example, assume that a user searches for a K5 car (gasoline) during a period from May 15 (SUN), 2016, 2:00 PM to May 17 (TUE), 2016, 4:00 PM. A total number of K5 (gasoline) cars was 50, 4 K5 (gasoline) cars were rented, and 46 K5 (gasoline) cars remained. The number of times of searching for the K5 (gasoline) car today was 15 and the number of reserved cars was 1. The number of gasoline cars today was 25, the number of LPG cars today was 60, the number of diesel cars today was 10, and the number of K5 (gasoline) cars was reduced from 46 to 45 in one hour, that is, one K5 (gasoline) car was rented in one hour. The prices of the K5 (gasoline) cars of 5 car-rental companies were respectively 19,000, 19,000, 20,000, 22,000 and 24,000. The minimum price of the K5 (gasoline) car is 15,000, the maximum price thereof is 55,000, and the price defined by the company is 24,000.

When the price is obtained using variable 1, since the rental period is three days including two weekdays and one weekend day, the variable (1/3=0.33) is calculated, and

24,000 (price)−((0.33*1.5(weight)/10)*24,000 (price))=23,040

is obtained. Therefore, 23,040 won (a) is calculated using variable 1.

When the price is obtained using variable 2, that is, the number of rented cars, a weight is applied to the variable (1/15=0.06) and the following price is calculated.

24,000 (price)−((0.06 (weight))*24,000 (price))=22,560

Therefore, 22,560 won (b) is calculated using variable 2.

Variable 3, that is, the number of cars of a fuel type selected by users on the current date, is obtained to calculate the price.

That is, because the number of gasoline cars selected by users today was 25, the number of diesel cars selected by users today was 10, the number of LPG cars selected by users today was 60 and the user selected the gasoline car, a weight is applied to the variable 3 (25/(60+10)=0.35), thereby calculating the following price.

24,000 (price)−((0.35*0.6 (weight))*24,000 (price))=18,960

Therefore, 18,960 won (c) is calculated using variable 3.

Variable 4, that is, the total number of remaining cars, is obtained to calculate the price.

That is, variable 4 indicates the number of remaining cars and is calculated as reduction in number of cars per hour. When the number of cars is 46 at 10:00 and is 45 at 10:59, variable 4 ((45/(46+45))²=0.25 is obtained to calculate the following price.

24,000 (price)−(0.25*24,000 (price))=18,000

Therefore, 18,000 won (d) is calculated using variable 4.

In the above processes, the minimum price v1 of the prices a, b, c and d calculated using variables 1 to 4 is 18,000 won.

Variable 5 is the average price of the car in car-rental companies on the current date as a comparison value.

That is, variable 5 is an average price of the car on the current date. When the prices of the same car in five car-rental companies are respectively 19,000, 19,000, 20,000, 22,000 and 24,000, the average price is obtained as follows.

(19,000+19,000+20,000+22,000+24,000)/5=20,800 won (e).

At this time, price adjustment is performed using the variables obtained in the price adjuster 143.

The lowest price v1 of the prices calculated by variables 1, 2, 3 and 4 is 18,000 won.

The average price obtained by variable 5 is 20,800 (v2). Since the calculated price (the minimum price of the prices obtained by variables 1 to 4) is less than the average price (variable 5) (v1<v2), the calculated price is selected.

If v1 is greater than v2, the smaller price of v2 and the price of the company is selected.

Since the adjusted price is within a range between the minimum price and the maximum price, the price of the company may be adjusted from 24,000 to 18,000 and is displayed to the user.

If the adjusted price is greater than the maximum price, the rental price is restricted to the maximum price.

The equation for obtaining the calculated price is merely exemplary and thus is not limited thereto and various calculation methods are applicable according to analysis of data received from the search database 300 and based on various algorithms.

Next, the price adjustment server 100 provides information on the adjusted price to the user terminal 200 along with the search result (S60).

Meanwhile, when the user terminal 200 inputs real-time reservation and payment information of the searched car to the price adjustment server 100, the price adjustment server 100 transmits user information and reservation and payment information to the rental-car management unit 500 of the car-rental company, makes reservation and payment, and requests car allocation (S70).

At this time, the price adjustment server transmits the reservation and payment information with the adjusted price information to the rental-car management unit of the car-rental company, receives real-time reservation and payment information with the adjusted price information from the rental-car management unit of the car-rental company, and transmits a response to the request for real-time car allocation to the user terminal 200 through the price adjustment server 100 (S80 and S90).

According to the present invention, when a user selects a desired car model according to a schedule or itinerary thereof, it is possible to adjust and propose a discount rate or an increase rate of each car-rental company in real time, to search for and compare the rental prices of available rental cars, and to reserve a desired rental car, and to pay the rental price and an insurance premium in real time.

In addition, according to the present invention, a car rental company can manage rental cars capable of being rented to many customers and reduce the number of idle rental cars, thereby maximizing earnings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A car rental system through price adjustment, comprising:
a price adjustment server configured to collect a desired car model, price and demand during the specific period within a predetermined area from the search database, to analyze a demand and schedule of the user, a desired price category of the user, a real-time total stock of the car-rental company and a base price as variables based on supply information of available rental cars of the car-rental company and the base price of the car-rental company through a rental-car management unit for delivering rental-car management information to calculate a price, and to provide an adjusted rental price to the user along with the search result; and
a user terminal configured to request price comparison search for an available rental car including a rental price of a rental car of a desired model to be rented by the user during the specific period from the price adjustment server through a communication network,
wherein the price adjustment server includes:
a search processor configured to receive, from the user terminal, the request for price comparison search for the rental car of the desired model to be rented during the specific period, requests search data of a rental date and time, a return date and time and car classification from the rental-car management unit, and to provide the model and price of the car as a search result in real time;
a data loading unit configured to load the search data of the rental date and time, the return date and time and car classification searched by the user terminal, user information, a search time of the user, data on a search result and final payment of the user from the search database;
a quantity management unit configured to store the quantity of cars when users search for cars and when cars are rented and to store and manage a total stock and a rate of sales of cars;
a pattern analyzer configured to use a rental period according to a weekend or weekday, the number of cars rented on a day of search, the number of cars of a model selected by the user rented on the day of search, reduction in number of remaining cars in one hour from a search time, and an average price of car-rental companies on the day of search as variables, with respect to the demand and schedule of the user who requests price comparison search, a user input value for the desired price, to calculate the rental price of the rental car; and
a base price management unit configured to set and store a base price of the sale car of each car-rental company and a range from a minimum price to a maximum price; and
a price adjuster configured to apply a price calculated using the variables set by the pattern analyzer within the range of the base price to adjust the price.

2. The car rental system according to claim 1, wherein the price adjustment server includes:
a screen output unit configured to output available car information and price information, to which the adjusted price is applied in real time according to car-rental company, on a screen of the user terminal, as a result generated by the price adjuster according to the request for price comparison request from the user terminal;
a car request unit configured to request car allocation from the rental-car management unit with respect to the car of the car-rental company, reservation of and payment for which has been performed through the user terminal;
a controller configured to perform control to receive the request for price comparison search from the user terminal, to load the data searched by the search processor using the data loading unit, to manage the quantity of cars, to compare the result calculated using the variables by the pattern analyzer with the base price, and to adjust the price.

3. The car rental system according to claim 1, wherein the pattern analyzer calculates the adjusted rental price by applying a weight to the rental period according to weekend or weekday, the number of cars rented on the day of search and the number of cars of the model selected by the user rented on the day of search as the variables.

4. The car rental system according to claim 1, wherein the price adjustment server receives the request for price comparison search for the rental car of the desired model to be rented during the specific period from the user terminal and provides car information and price information, and the car information includes insurance application information and the price information include an insurance premium.

5. A car rental method comprising:
a user terminal requesting search for a rental car to be rented during a specific period from a price adjustment server;
the price adjustment server storing search information including a use period, model and desired price of the rental car received from the user terminal in a search database;
the price adjustment server delivering the search information to a rental-car information provision server and requesting search for the rental car;
the rental-car information provision server requesting search for a list of rental cars and use prices thereof from a rental-car management unit of a car-rental company and the rental-car management unit transmitting a search result to the rental-car information provision server in response thereto;
the price adjustment server receiving the search result from the rental-car information provision server and analyzing a demand and schedule of a user, a desired price category of the user, a real-time total stock of the car-rental company and a base price as variables to calculate a price, and adjusting a rental price;
the price adjustment server providing the calculated price to the user terminal as the information on the adjusted rental price if the price calculated using the variables is within the range from a minimum price and a maximum price of a base price of a sales car of each car-rental company; and
the price adjustment server providing information on the adjusted rental price to the user terminal along with the search result.

6. The car rental method according to claim 5, further comprising, when the user terminal inputs real-time reservation and payment information of the searched rental car to the price adjustment server, the price adjustment server transmits user information and the reservation and payment information to the rental-car management unit of the car-rental company to make reservation and payment and requests car allocation.

7. The car rental method according to claim 5, wherein the price adjustment server transmits reservation and payment information with the adjusted price information to the rental-car management unit of the car-rental company, receives real-time reservation and payment information with the adjusted price information from the rental-car management unit of the car-rental company, and transmits a response to a request for real-time car allocation to the user terminal through the price adjustment server as car allocation information.
